(19) United States
(12) Patent Application Publication
(10) Pub. No.: US 2006/0218181 A1
(43) Pub. Date: Sep. 28, 2006

(54) Authentication and personal content transmission method for sharing personal contents and display apparatus and server thereof

(75) Inventor: Seung-hun Jeon, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/322,555

(22) Filed: Jan. 3, 2006

(30) Foreign Application Priority Data
Mar. 24, 2005 (KR) 10-2005-0024544

(51) Int. Cl. G06F 17/00

(52) U.S. Cl. 707/103 R

(57) ABSTRACT

A method of authenticating and transmitting personal contents in order to easily share personal contents with acquaintances by using a display apparatus capable of accessing a network, and a display apparatus and a server therefor are provided. The method of transmitting contents includes: the display apparatus receiving at least one personal content of the at least one acquaintance from the server through the network; storing the received personal contents in relation to each acquaintance; and if the personal contents of the acquaintance are requested by the user of the display apparatus, reading the personal contents of the acquaintance among the stored personal contents and displaying the read personal contents. According to the method and apparatus, even when the user of the display apparatus does not perform linking with a corresponding server (or service provider), personal contents can be easily shared with acquaintances.

### CROSS-REFERENCE TO RELATED PATENT APPLICATIONS

This application claims priority from Korean Patent Application No. 10-2005-0024544, filed on Mar. 24, 2005, in the Korean Intellectual Property Office, the disclosure of which is incorporated herein in its entirety by reference.

### BACKGROUND OF THE INVENTION

1. Field of the Invention

The present invention relates to a method of sharing personal contents and a display apparatus and a server appropriate to the method, and more particularly, to a method of authenticating and transmitting personal contents in order to share personal contents with acquaintances by using a display apparatus capable of connecting a network, and a display apparatus and a server therefor.

2. Description of the Related Art

Recently, blog homepages to share personal contents, such as moving pictures and photos, have been continuously emerging on the Internet. In a generally known home page, contents can be shared based on a host, while personal contents can be shared with acquaintances based on post in a blog homepage. Acquaintances are set under conditions such as relatives, same provinces, and alumni. Accordingly, the blog homepage is more relationship-oriented compared to the host-based homepage. An example of this blog homepage is cyworld.com.

However, in the conventional blog homepage, only after a user accesses a corresponding service provider on the Internet and performs a series of access steps to access the user's blog homepage, personal contents can be shared with acquaintances.

Accordingly, it is difficult for a person who does not know a method of accessing a blog homepage by using a device capable of accessing a computer or the Internet, to use a community service sharing personal contents with acquaintances. Also, even though the person knows the method of accessing the blog homepage, it is annoying that whenever personal contents are desired to be shared, the blog homepage of the service provider should be accessed, by performing multiple steps. For example, a computer is turned on, a web browser is opened, a uniform resources locator (URL) is typed in, and user login is performed. Only after performing these steps, the blog homepage is accessed and personal contents can be shared with acquaintances.

### SUMMARY OF THE INVENTION

The present invention provides a method of authenticating and transmitting personal contents in order to easily share personal contents with acquaintances by using a display apparatus capable of accessing a network, and a display apparatus and a server therefor.

According to an aspect of the present invention, there is provided a method of transmitting personal contents to be shared with at least one acquaintance, by using a display apparatus capable of accessing a server through a network, the method including: the display apparatus receiving at least one personal content of the at least one acquaintance from the server through the network; storing the received personal contents in relation to each acquaintance; and if the personal contents of the acquaintance are requested by the user of the display apparatus, reading the personal contents of the acquaintance among the stored personal contents and displaying the read personal contents.

According to another aspect of the present invention, there is provided a method of transmitting personal contents to be shared with at least one acquaintance, by using a display apparatus capable of accessing a server through a network, the method including: the display apparatus receiving at least one personal content of the at least one acquaintance and meta data corresponding to the at least one personal content from the server through the network; storing the received personal contents and meta data in relation to each acquaintance; and if the personal contents of the acquaintance are requested by the user of the display apparatus, reading the personal contents of the acquaintance among the stored personal contents and displaying the read personal contents.

According to still another aspect of the present invention, there is provided a method of transmitting personal contents to be shared with at least one acquaintance, by using a server capable of accessing at least one display apparatus through a network, the method including: the server requesting the personal contents of the acquaintance stored in the display apparatus; receiving the personal contents of the acquaintance from the display apparatus; comparing the received personal contents of the acquaintance with the personal contents of the acquaintance maintained in the server; and if there are personal contents different from the received personal contents of the acquaintance among the personal contents of the acquaintance maintained in the server, providing the different personal contents to the display apparatus.

According to yet still another aspect of the present invention, there is provided a method of transmitting personal contents to be shared with at least one acquaintance, by using a server capable of accessing at least one display apparatus through a network, the method including: the server requesting the meta data of the personal contents of the acquaintance stored in the display apparatus; receiving the meta data of the personal contents of the acquaintance from the display apparatus; comparing the received meta data of the personal contents of the acquaintance with the meta data of the personal contents of the acquaintance maintained in the server; and if there are meta data different from the meta data of the received personal contents of the acquaintance among the meta data of the personal contents of the acquaintance maintained in the server, providing the different meta data and the personal contents corresponding to the meta data to the display apparatus.

According to a further aspect of the present invention, there is provided an authenticating method for sharing personal contents with at least one acquaintance by using a display apparatus capable of accessing a server through a network, the method including: if the display apparatus begins a first operation and is connected to the network, requesting the contact details of the user of the display apparatus; if the contact detail information of the user is input, providing the contact detail information of the user to the server; if a message from the server confirming permission of sharing personal contents in relation to the display apparatus user is received, requesting input of the contact detail information of the acquaintance of the display apparatus user; if the contact detail information of the acquaintance is input, providing the contact detail information of the acquaintance to the server; and if acquaintance list information on acquaintances permitting sharing of personal contents from the sever is received, setting the received acquaintance list information as the acquaintance list information of the display apparatus user.

According to an additional aspect of the present invention, there is provided an authenticating method for sharing personal contents with at least one acquaintance by using a server capable of accessing at least one display apparatus through a network, the method including: if contact detail information from the display apparatus is received, the server confirming to the display apparatus user whether or not sharing of personal contents is permitted, by using an automatic response system; if the display apparatus user permits sharing of the personal contents, transmitting a message confirming permission of sharing the personal contents, to the display apparatus user, and registering the contact detail information of the display apparatus user and unique identification information of the display apparatus; if the contact detail information of the acquaintance of the display apparatus user is received, by using the automatic response system, in relation to each acquaintance based on the received contact detail information of the acquaintance, confirming whether or not sharing of the personal contents is permitted; and registering an acquaintance list, including information on acquaintances permitting the sharing of the personal contents, as the acquaintance list of the display apparatus user and providing the acquaintance list information of the display apparatus user to the display apparatus, wherein the server registers the contact detail information of the display apparatus user, the unique identification information of the display apparatus, and the acquaintance list of the display apparatus such that the contact detail information, the unique identification information and the acquaintance list are capable of referring to each other.

According to an additional aspect of the present invention, there is provided a display apparatus capable of accessing a server through a network, the apparatus including: a transmission and reception unit communicating data with the server through the network; a storage unit storing personal contents in relation to each acquaintance; an input unit inputting commands of a user and/or information; a control unit, if at least one personal content of at least one acquaintance is received through the transmission and reception unit, performing control so that the received personal contents are stored in relation to each acquaintance in the storage unit, and if the personal contents of the acquaintance are requested by the input unit, performing control so that the personal contents of the acquaintance stored in the storage unit are output; and a display unit displaying the personal contents output from the storage unit.

According to an additional aspect of the present invention, there is provided a display apparatus capable of accessing a server through a network, the apparatus including: a transmission and reception unit communicating data with the server through the network; a storage unit storing personal contents and the meta data corresponding to the personal contents in relation to each acquaintance; an input unit inputting commands of a user and information; a control unit, if at least one personal content of at least one acquaintance and the meta data corresponding to the personal content are received through the transmission and reception unit, performing control so that the received personal content and the meta data corresponding to the personal content are stored in the storage unit, and if the personal contents of the acquaintance are requested by the input unit, performing control so that the personal contents of the acquaintance stored in the storage unit are output; and a display unit displaying the personal contents output from the storage unit.

According to an additional aspect of the present invention, there is provided a server capable of accessing at least one display apparatus through a network, the server including: a transmission and reception unit capable of communicating data with at least one display apparatus; a first storage unit storing the unique identification information of the at least one display apparatus, the contact details of the display apparatus user, and an acquaintance list; a second storage unit storing personal contents of a predetermined person; and a control unit requesting the personal contents of the predetermined person through the transmission and reception unit to a display apparatus storing the personal contents of the predetermined person, based on the acquaintance list and the unique identification information stored in the first storage unit, and if the personal contents of the predetermined person are received through the transmission and reception unit, examining whether or not there are personal contents different from the received personal contents among the personal contents stored in the second storage unit, and if it is determined that there are different personal contents, performing control so that the different personal contents are transmitted to the display apparatus through the transmission and reception unit.

### BRIEF DESCRIPTION OF THE DRAWINGS

The above and other features and advantages of the present invention will become more apparent by describing in detail non-limiting, exemplary embodiments thereof with reference to the attached drawings in which:

FIG. 1 illustrates the structure of a network according to a non-limiting embodiment of the present invention;

FIG. 2 is a functional block diagram of the first through n-th display apparatuses shown in FIG. 1;

FIG. 3 illustrates an example of an acquaintance list displayed on a display unit shown in FIG. 2;

FIG. 4 is a conceptual diagram of personal contents stored in a storage unit shown in FIG. 2 and meta data corresponding to the personal contents;

FIG. 5 is a functional block diagram of a server shown in FIG. 1;

FIG. 6 is an operational flowchart of an authentication method for sharing personal contents according to a non-limiting embodiment of the present invention;

FIG. 7 is an example of an operational flowchart of a personal content output process in a personal content transmission method according to the present invention;

FIG. 8 is another example of an operational flowchart of a personal content output process in a personal content transmission method according to the present invention;

FIG. 9 is an example of an operational flowchart of a personal content update process in a personal content transmission method according to the present invention;

FIG. 10 is another example of an operational flowchart of a personal content update process in a personal content transmission method according to the present invention; and

FIG. 11 is still another example of an operational flowchart of a personal content update process in a personal content transmission method according to the present invention.

### DETAILED DESCRIPTION OF THE INVENTION

The present invention will now be described more fully with reference to the accompanying drawings, in which non-limiting, exemplary embodiments of the invention are shown.

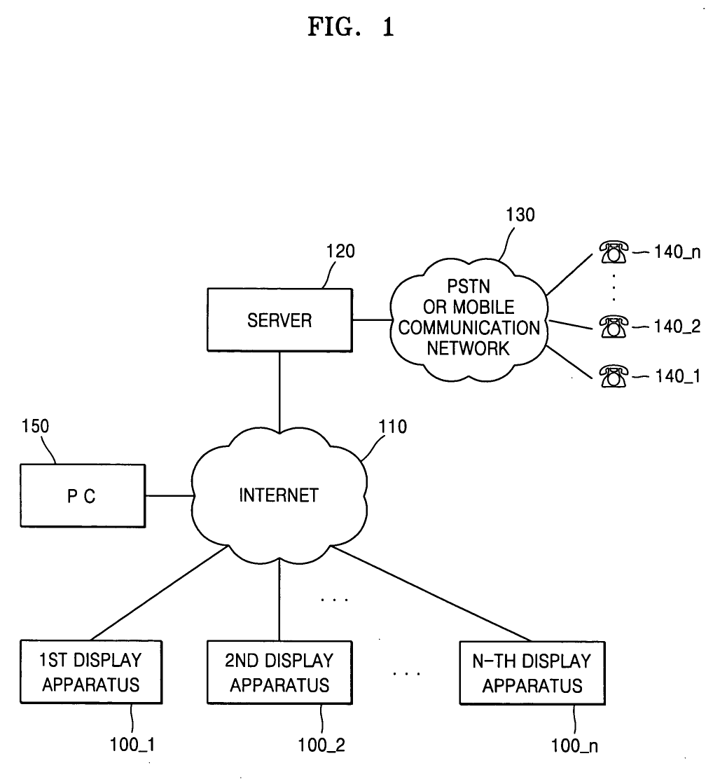

Referring to FIG. 1, a network according to a preferred embodiment of the present invention includes first through n-th display apparatuses 100_1˜100_n, the Internet 110, a server 120, a public switched telephone network (PSTN) or a mobile communication network 130, first through n-th telephones 140_1˜140_n, and a personal computer (PC) 150.

The first through n-th display apparatuses 100_1˜100_n includes apparatuses, such as a television (TV) that can be connected to a network, a digital camera or camcorder that can be connected to a network, a mobile phone that can be connected to a network, and a personal media player (PMP) that can be connected to a network. In case of the TV, the TV may have a structure combined with a set-top box.

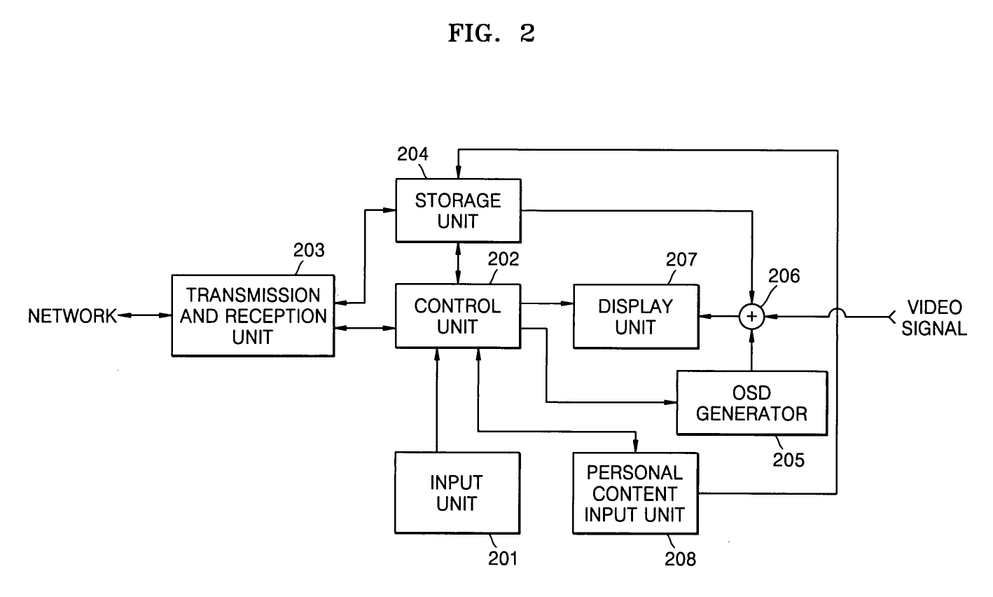

In order to provide a function for sharing personal contents with acquaintances specified by a user, the first through n-th display apparatuses 100_1˜100_n may have a structure as shown in the functional block diagram of FIG. 2.

Referring to FIG. 2, the first through n-th display apparatuses 100_1˜100_n can include each of an input unit 201, a control unit 202, a transmission and reception unit 203, a storage unit 204, an on screen display (OSD) generator 205, a synthesizer 206, a display unit 207, and a personal content input unit 208.

The input unit 201 is formed so that a user can input a command and/or information desired to be input. Accordingly, the input unit 201 can be formed with function key buttons or a touch panel corresponding to commands and information that can be input by the user. Also, the input unit 201 can be formed with a receiver receiving commands and/or information of the user input through a remote control method.

According to a non-limiting embodiment of the present invention, the input unit 201 can be used to input contact details of the user, that of acquaintances, a network connection request, and commands related to selection of personal contents desired to be displayed. The contact details of the user and acquaintances can be home phone numbers, mobile phone numbers, or e-mail addresses. The commands related to selection of personal contents desired to be displayed can include a request of an acquaintance list of the display apparatus user, and selection information based on an acquaintance list.

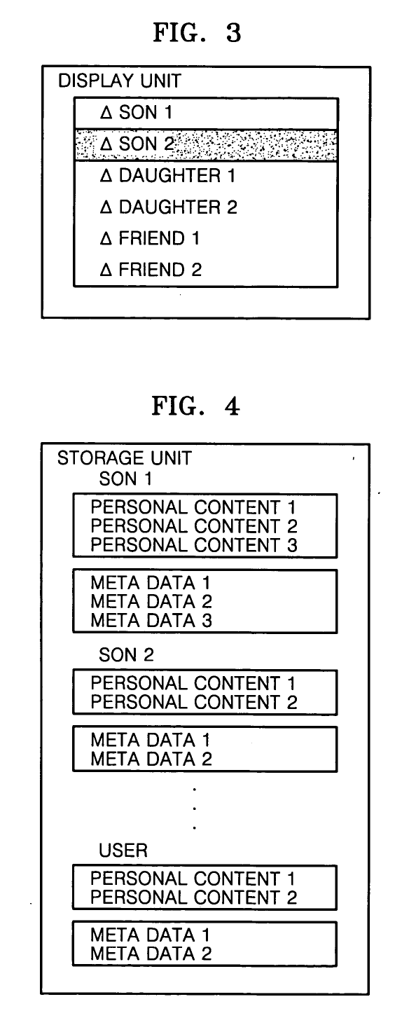

The acquaintance list can be defined as shown in FIG. 3. FIG. 3 shows a case where acquaintances of the display apparatus user, sons 1 and 2, daughters 1 and 2, friends 1 and 2, are registered. The selection information based on the acquaintance list can be son 2 on which the cursor is positioned in FIG. 3. The acquaintance list can be displayed on the display unit 207 in an OSD mode.

The commands and/or information input through the input unit 201 are provided to the control unit 202.

The transmission and reception unit 203 communicates data with the server 120 through a network such as the Internet 110 of FIG. 1. Data transmitted and received can include personal contents, meta data corresponding to the personal contents, a variety of request signals, and a confirmation message. The transmission and reception unit 203 can include an Ethernet port.

The storage unit 204 is controlled by the control unit 202 and stores personal contents of acquaintances received through the transmission and reception unit 203, in relation to each acquaintance. That is, as shown in FIG. 4, personal contents and the meta data corresponding to the personal contents can be stored by acquaintance. Referring to FIG. 4, in case of the son 1, the storage unit 204 stores personal content 1, personal content 2, and personal content 3, and separately stores meta data 1 corresponding to the stored personal content 1, meta data 2 corresponding to the stored personal content 2, and meta data 3 corresponding to the stored personal content 3. The personal contents 1 through 3 can be still images or text. The meta data 1 through 3 can have a text format or can be defined in an extensible markup language (XML).

Also, the storage unit 204 can store personal contents of the display apparatus user and meta data corresponding to the personal contents separately as a storage area defined as “user” in FIG. 4. The personal contents of the display apparatus user can be input through the personal content input unit 208.

In case of FIG. 4, the storage unit 204 stores personal contents and the meta data corresponding to the personal contents. However, the storage unit 204 can store only personal contents of each acquaintance and the display apparatus user. Also, the storage unit 204 can use a flash memory.

The OSD generator 205 is controlled by the control unit 202 and can generate the acquaintance list as shown in FIG. 3, other confirmation messages, and a message for request to the display apparatus user, as OSD information.

The synthesizer 206 is controlled by the control unit 202 and provides at least one of a video signal received from the outside, personal contents provided by the storage unit 204, and the OSD generated by the OSD generator 205, to the display unit 207. Accordingly, the signal output from the synthesizer can be a signal in which the personal contents and the OSD are overlapped, or the received video signal and the OSD are overlapped, or the received video signal, the personal contents, and the OSD are all overlapped.

The display unit 207 displays a signal provided by the synthesizer 206. In particular, personal contents, an acquaintance list, a confirmation message, and a request message can be displayed.

The content input unit 208 can be used to input personal contents of the display apparatus user. The content input unit 208 can be formed with a camera or an external input terminal. When it is formed with an external input terminal, the content input unit 208 can receive contents provided by a capture device such as a camera, and transmit the contents to the storage unit 204.

When at least one personal content of at least one acquaintance or personal contents and the meta data corresponding to the personal contents are received through the transmission and reception unit 203, the control unit 202 performs control so that the received personal contents or the personal contents and the meta data corresponding to the personal contents can be stored in the storage unit 204 by acquaintance.

If an acquaintance list is requested by the input unit 201, the control unit 202 controls the OSD generator 205 so that the acquaintance list is displayed on the display unit 207, and if contents of a specific acquaintance are requested based on the acquaintance list, the control unit 202 performs control so that the personal contents of the acquaintance stored in the storage unit 204 can be output.

In addition, if a signal requesting the personal contents of an acquaintance or meta data corresponding to the personal contents is received through the transmission and reception unit 203, the control unit 202 reads the personal contents of the acquaintance or meta data together stored in the storage unit 204, and provides the data to the server 120 through the transmission and reception unit 203.

After that, if at least one personal content of at least one acquaintance or personal contents and the meta data corresponding to the personal contents are received through the transmission and reception unit 203, the control unit 202 updates the personal contents of the acquaintance or personal contents and the meta data corresponding to the personal contents so that the received personal contents or personal contents and the meta data corresponding to the personal contents can be included in the personal contents of the acquaintance or personal contents and the meta data corresponding to the personal contents stored in the storage unit 204.

Then, if at least one personal content is input through the content input unit 208, the control unit 202 controls the storage unit 204 and the personal content input unit 208 in order to store the input personal content in the storage unit 204, controls the transmission and reception unit 203 in order to transmit the input personal content to the server 120. At this time, meta data corresponding to the personal content input through the content input unit 208 can be input together through the content input unit 208 or through the input unit 201. If the meta data corresponding to the input personal content is input, the control unit 202 can transmit the meta data to the server 120 while storing the meta data together with in the storage unit 204.

As described above, in order to share personal contents with acquaintances, the first through n-th display apparatuses 100_1˜100_n can perform an authentication procedure for the display apparatus user and acquaintances.

That is, if it is determined that the display apparatus is first operated after the user purchases the apparatus and that by a request of the user the display apparatus is connected to a network such as the Internet 110 through the transmission and reception unit 203, the control unit 202 controls the OSD generator 205 such that a message requesting input of contact details of the current user is displayed on the display unit 207. If the contact detail information of the user is input through the input unit according to the message, the information is transmitted to the server through the transmission and reception unit 203. If a confirmation message from the server 120 permitting the display apparatus user to share personal contents is received through the transmission and reception unit 203, the control unit 202 controls the OSD generator 205 such that a message requesting input of contact details of at least one acquaintance with whom the current user wants to share the personal contents is displayed on the display unit 207.

If the contact detail information of the acquaintance is input through the input unit 201 according to the message, the control unit 202 transmits the contact detail information of the input acquaintance to the server 120 through the transmission and reception unit 203.

If an acquaintance list including information of the acquaintance whom the display apparatus user permits to share personal contents is received from the server 120 through the transmission and reception unit 203, the control unit 202 stores the received acquaintance list in the storage unit 204 so that the received acquaintance list is set as the acquaintance list of the current user of the display apparatus. Through this process, acquaintance lists of a plurality of users can be set in one display apparatus.

The server 120 can be connected to first through n-th display apparatuses 100_1˜100_n and the PC 150 through a network such as the Internet 110. Also, the server 120 can be connected to a plurality of telephones 140_1 through 140_n (or mobile phones) through the PSTN or the mobile communication network 130.

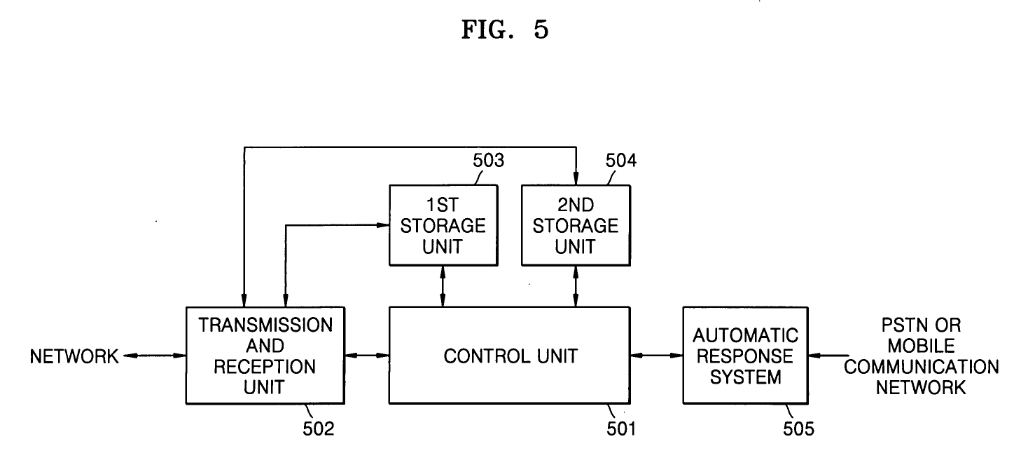

In order to provide a personal content sharing service according to the present invention, the server 120 can be formed as shown in FIG. 5. Referring to FIG. 5, the server 120 can include a control unit 501, a transmission and reception unit 502, a first storage unit 503, a second storage unit 504, and an automatic response system 505.

The transmission and reception unit 502 communicates data with the first through n-th display apparatuses 100_1˜100_n and the PC 150. The first storage unit 503 stores unique identification information of the first through n-th display apparatuses 100_1˜100_n, contact details of the display apparatus users who want to share personal contents, and an acquaintance list in relation to each user.

The second storage unit 504 stores personal contents of a predetermined person or personal contents and the meta data corresponding to the personal contents. That is, without a request from the server 120, if personal contents or personal contents and the meta data corresponding to the personal contents are received through the transmission and reception unit 502, the contents and meta data are controlled by the control unit 501 and stored in the second storage unit 504.

If personal contents or personal contents and the meta data corresponding to the personal contents are received through the transmission and reception unit 502 and stored in the second storage unit 504, the control unit 501 retrieves a display apparatus in which the person who provided the personal contents or personal contents and the meta data corresponding to the personal contents stored in the second storage unit 504 is registered as an acquaintance, based on the acquaintance list and unique identification information of the display apparatus stored in the first storage unit 503.

If the display apparatus is retrieved, the control unit 501 requests the personal contents of the acquaintance or meta data corresponding to the personal contents to the retrieved display apparatus through the transmission and reception unit 502 and the Internet 110. According to the request, if the personal contents or meta data corresponding to the personal contents are received through the transmission and reception unit 502, the control unit 501 compares personal contents or meta data corresponding to the personal contents stored in the second storage unit 504 with the received personal contents or meta data corresponding to the personal contents.

As a result, if among the personal contents or meta data corresponding to the personal data stored in the second storage unit 504 there are personal contents or meta data corresponding to the personal contents different from the received personal contents or meta data corresponding to the personal contents, the control unit 501 reads the different personal contents and corresponding meta data stored in the second storage unit 504, and transmits the different contents and meta data to the corresponding display apparatus through the transmission and reception unit 502.

As described above, in order to transmit personal contents for sharing, the server 120 can perform an authentication procedure between the user of the first through n-th display apparatuses 100_1˜100_n and an acquaintance specified by the user.

That is, if contact details of the display apparatus user for sharing personal contents and unique identification information of the display apparatus are received through the transmission and reception unit 502, the control unit 501 operates the automatic response system 505 based on the contact details of the user or transmits a message through the transmission and reception unit 502.

If the contact detail is a wired telephone number, the control unit 501 operates the automatic response system 505 and the automatic response system 505 makes a call through the PSTN 130 such that whether or not the display apparatus user permits sharing of personal contents is confirmed. If the contact detail is a mobile phone number, the control unit 501 operates the automatic response system 505 and the automatic response system 505 confirms through the mobile communication network 130 whether or not the display apparatus user permits sharing of personal contents. If the contact detail is an e-mail address, the control unit 501 confirms to the PC 150 through the Internet 110 whether or not the display apparatus user permits sharing of personal contents.

As the result of the confirmation, if it is determined that the display apparatus user permits sharing of personal contents, the control unit 501 transmits a message confirming permission of sharing of personal contents of the user, to the display apparatus through the transmission and reception unit 502.

According to the message, if the acquaintance contact detail information of the user is received through the transmission and reception unit 502, the control unit 501 confirms for each acquaintance based on the received acquaintance contact detail information, whether or not sharing of personal contents is permitted.

As a confirmation method, the automatic response system 505 may be operated to perform confirmation with respect to the type of the received contact detail information or through the transmission and reception unit 502, confirmation may be performed as in the user confirmation method described above.

If the user and acquaintances whom the user permits to share personal contents are determined through the confirmation process, the control unit 501 stores an acquaintance list including the determined acquaintance information in the first storage unit 503, as the acquaintance list information of the user, and transmits the acquaintance list information of the user to the corresponding display apparatus through the transmission and reception unit 502.

If the message from the server 120 confirming whether or not sharing of personal contents is permitted is received through the Internet 110 by using an e-mail, the PC 150 can transmit a response message to the message. Also, collected personal contents or personal contents and the meta data corresponding to the personal contents can be uploaded to the server 120 through the Internet 110. Then, after the PC 150 is authenticated for sharing personal contents as the first through n-th display apparatuses 100_1˜100_n, the PC 150 can transmit personal contents for sharing between the acquaintance and the user of the PC 150.

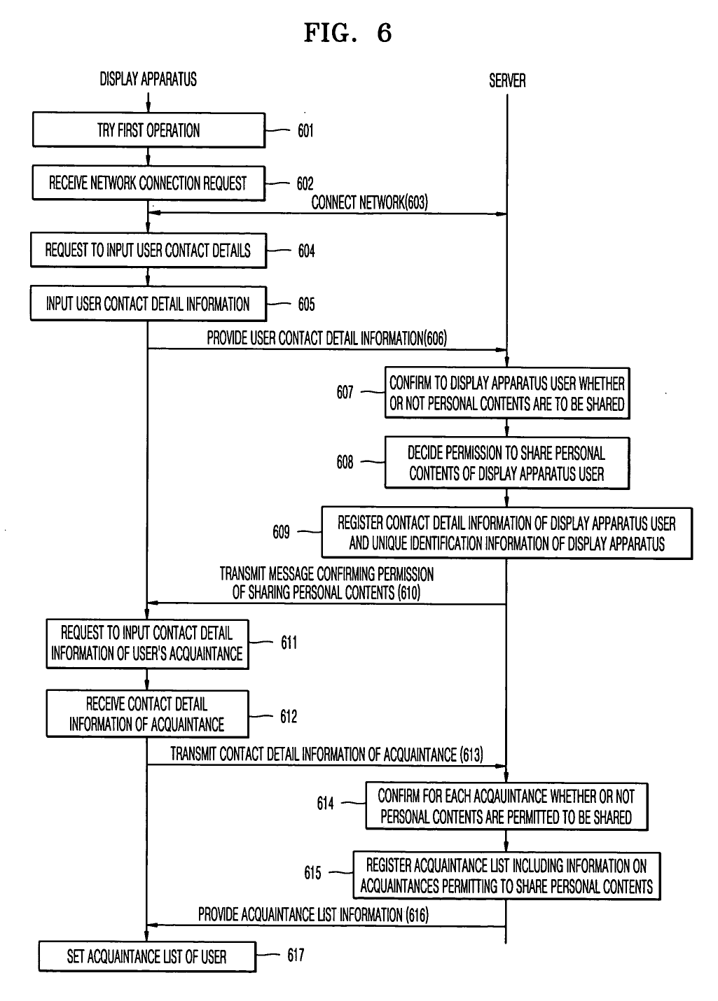

FIG. 6 is an operational flowchart of an authentication method for sharing personal contents according to a non-limiting embodiment of the present invention. The display apparatus of FIG. 6 can be one of the first through n-th display apparatus 100_1˜100_n and the PC 150 of FIG. 1.

First, after the display apparatus begins a first operation in operation 601, if a network connection request from a user is received in operation 602, the display apparatus performs connection to the server 120 through a network such as the Internet 110 in operation 603.

If the server 120 is connected through the network, the display apparatus requests contact details of the user to the user in operation 604. According to the request, if the contact detail information of the user is input by the user in operation 605, the display apparatus provides the input contact detail information of the user to the server 120 in operation 606.

If the contact detail information of the display apparatus user is received, the server 120 confirms based on the received contact detail information whether or not sharing of personal contents is permitted, to the display apparatus user. The confirmation method is the same as described above with reference to FIG. 5.

As the result of the confirmation, if it is determined that the display apparatus user permits sharing of the personal contents, the server 120 registers contact detail information of the display apparatus user and unique identification information of the display apparatus in operation 609, and transmits a message confirming permission of sharing of the personal contents of the user, to the display apparatus in operation 610.

If the message confirming permission of sharing of the personal contents of the user is received, the display apparatus requests the user to input contact detail information of an acquaintance whom the user wants to share the personal contents in operation 611. According to the request, if the contact detail information of the acquaintance from the user is received in operation 612, the display apparatus transmits the received contact detail information of the acquaintance to the server 120 in operation 613.

The server 120 confirms for each acquaintance based on the received contact detail information whether or not sharing of personal contents is permitted in operation 614. The confirmation method can be performed with respect to the type of the received contact detail information in the same manner as described above with reference to FIG. 5.

If an acquaintance to share personal contents with the display apparatus user is determined based on the confirmation result, the server 120 registers an acquaintance list, including the determined acquaintance information, as an acquaintance list of the display apparatus user in operation 615, and transmits the acquaintance list information to the display apparatus in operation 616. Then, the display apparatus sets the acquaintance list of the display apparatus user with the received acquaintance list information in operation 617.

Through the authentication process described above, acquaintance lists of a plurality of users can be set in one display apparatus.

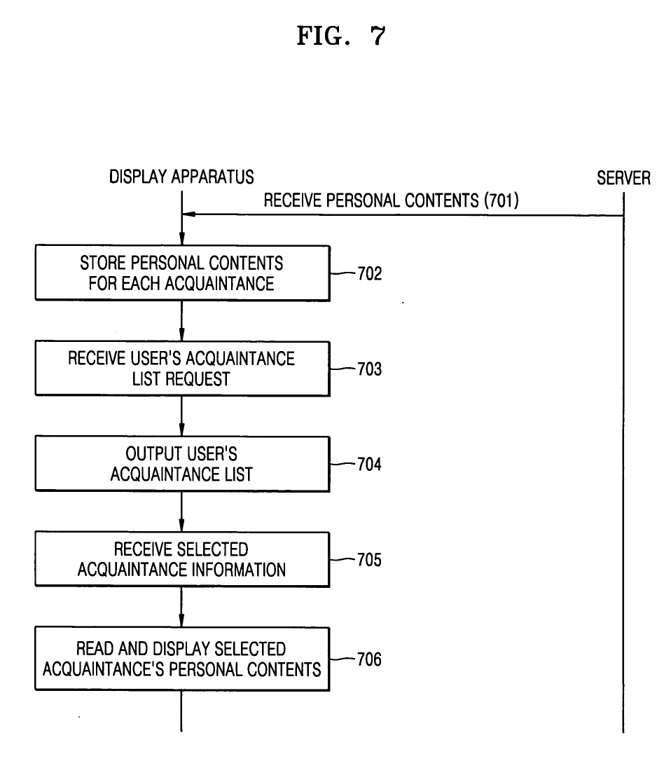

If the authentication for sharing personal contents between the display apparatus user and the acquaintance is finished according to the method of FIG. 6, personal contents desired to be shared can be transmitted through processes shown in FIGS. 7 through 11.

FIG. 7 is a non-limiting example of an operational flowchart of a personal content output process in a personal content transmission method according to the present invention. The display apparatus of FIG. 7 is the same as that of FIG. 6.

If at least one personal content from the server 120 is received through a network such as the Internet 110 in operation 701, the display apparatus stores the received personal contents by acquaintance as shown in FIG. 4 in operation 702.

If an acquaintance list request from the display apparatus user is received in operation 703, the display apparatus outputs the acquaintance list stored in advance through the authentication process described above in operation 704. The acquaintance list can be displayed on the display unit 207 in an OSD mode as described above with reference to FIG. 2.

If acquaintance information selected based on the output acquaintance list is received in operation 705, the display apparatus reads the personal contents of the selected acquaintance among personal contents stored in the storage unit 204 and displays the personal contents on the display unit 207 as described above with reference to FIG. 2 in operation 706. Accordingly, the display apparatus user can watch all personal contents of the desired acquaintance currently stored in the display apparatus. If there are a plurality of personal contents of the desired acquaintance, the display apparatus can display the plurality of personal contents in the form of multiple screens.

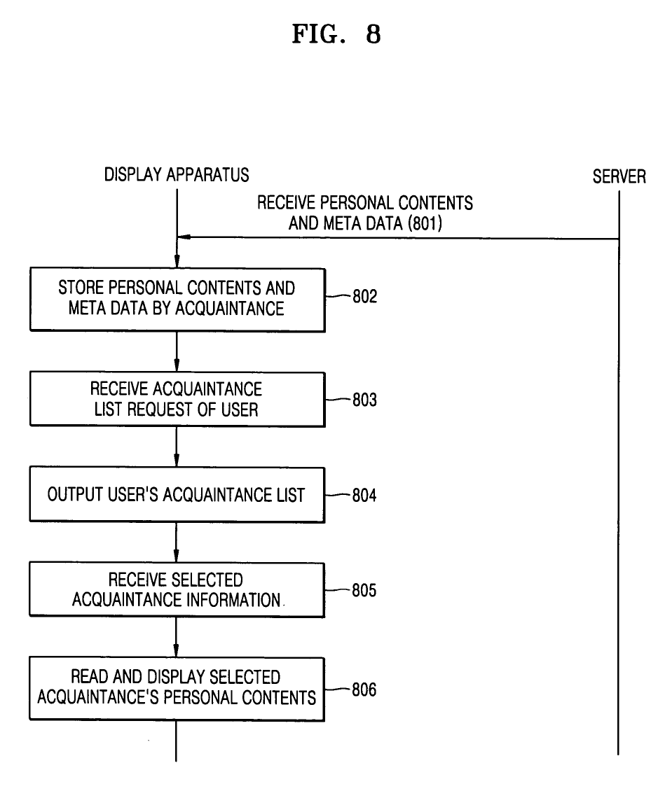

FIG. 8 is another non-limiting example of an operational flowchart of a personal content output process in a personal content transmission method according to the present invention. In this non-limiting example, personal contents and the meta data corresponding to the personal contents are managed together unlike in FIG. 7.

That is, if at least one personal content and the meta data corresponding to the personal content from the server 120 are received through a network such as the Internet 110 in operation 801, the display apparatus stores the received personal content and the meta data corresponding to the personal content by acquaintance as shown in FIG. 4 in operation 802.

If an acquaintance list request from the display apparatus user is received in operation 803, the display apparatus outputs the acquaintance list stored in advance through the authentication process described above in operation 804. The acquaintance list can be displayed on the display unit 207 in an OSD mode as described above with reference to FIG. 2.

If acquaintance information selected based on the output acquaintance list is received in operation 805, the display apparatus reads the personal contents of the selected acquaintance among personal contents stored in the storage unit 204 and displays the personal contents on the display unit 207 as described above with reference to FIG. 2 in operation 806. Accordingly, the display apparatus user can watch all personal contents of the desired acquaintance currently stored in the display apparatus.

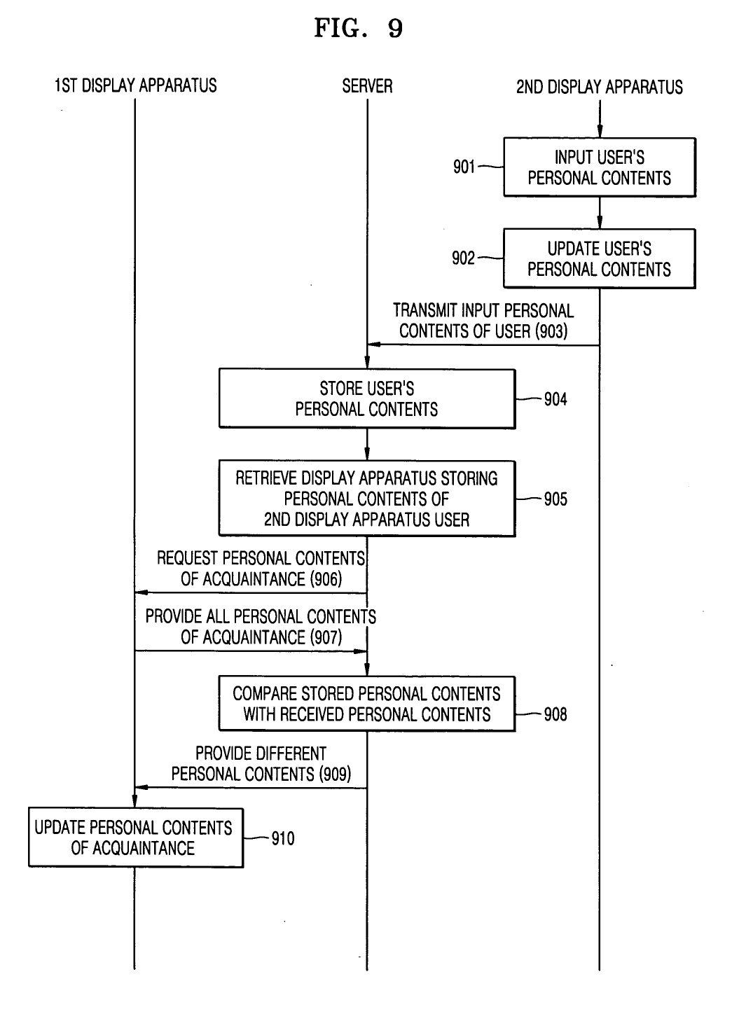

FIG. 9 is a non-limiting example of an operational flowchart of a personal content update process in a personal content transmission method according to the present invention. That is, if the acquaintance list of the user is set in the display apparatus and at least one personal content of at least one acquaintance is stored according to the method shown in FIG. 6, the personal contents stored in the display apparatus can be updated as shown in FIG. 9.

Also, in FIG. 9, a first display apparatus and a second display apparatus are different and FIG. 9 illustrates a case where the first display apparatus registers the second display apparatus user as an acquaintance desired to share personal contents. Accordingly, the first display apparatus can be the same apparatus as the display apparatus of FIGS. 6 through 8.

If a personal content of the second display apparatus user is input in operation 901, the second display apparatus updates the personal contents of the user in operation 902. Then, the input personal content of the user is transmitted to the server 120 in operation 903. At this time, a plurality of personal contents of the second display apparatus user can be transmitted.

The server 120 stores the received personal content of the user in operation 904. In case of FIG. 9, the received personal content of the user is stored in the second storage unit 504.

The server 120 retrieves a display apparatus storing personal contents of the second display apparatus user, based on an acquaintance list by display apparatus user stored in the first storage unit 503 in operation 905.

If the display apparatus is retrieved and the retrieved display apparatus is the first display apparatus, the server 120 requests the personal content of the second display apparatus user to the first display apparatus in operation 906. At this time, the second display apparatus user is an acquaintance of the first display apparatus user. Accordingly, the operation 906 can be defined as requesting the personal contents of the corresponding acquaintance.

According to the request, the first display apparatus reads all the stored personal contents of the acquaintance and provides the personal contents to the server 120 in operation 907. The server 120 compares all the personal contents received of the acquaintance with the personal contents stored in the second storage unit 504 in operation 908.

If the result of the comparison indicates that there are personal contents different from the received personal contents among the personal contents stored in the second storage unit 504, the server 120 provides the different personal contents to the first display apparatus in operation 909. At this time, if a plurality of personal contents are stored in the second storage unit 504 and all the plurality of personal contents are different from the received personal contents, the server 120 provides the plurality of personal contents to the first display apparatus.

The first display apparatus updates the personal contents of the acquaintance so that the received personal contents are included in the stored personal contents of the acquaintance in operation 910.

FIG. 9 shows the case where the user of the second display apparatus is registered as an acquaintance of the first display apparatus. However, if as the result of the retrieval in the operation 905, a plurality of display apparatuses having the second display apparatus user as an acquaintance registered therein are retrieved, the server 120 performs the operations 906 through 910 for the plurality of the retrieved display apparatuses such that the personal contents of the second display apparatus stored in each of the display apparatuses are updated.

In FIG. 9, the second display apparatus can also be the PC 150 of FIG. 1.

In addition, the second display apparatus can be a PMP, camera, camcorder, or mobile phone.

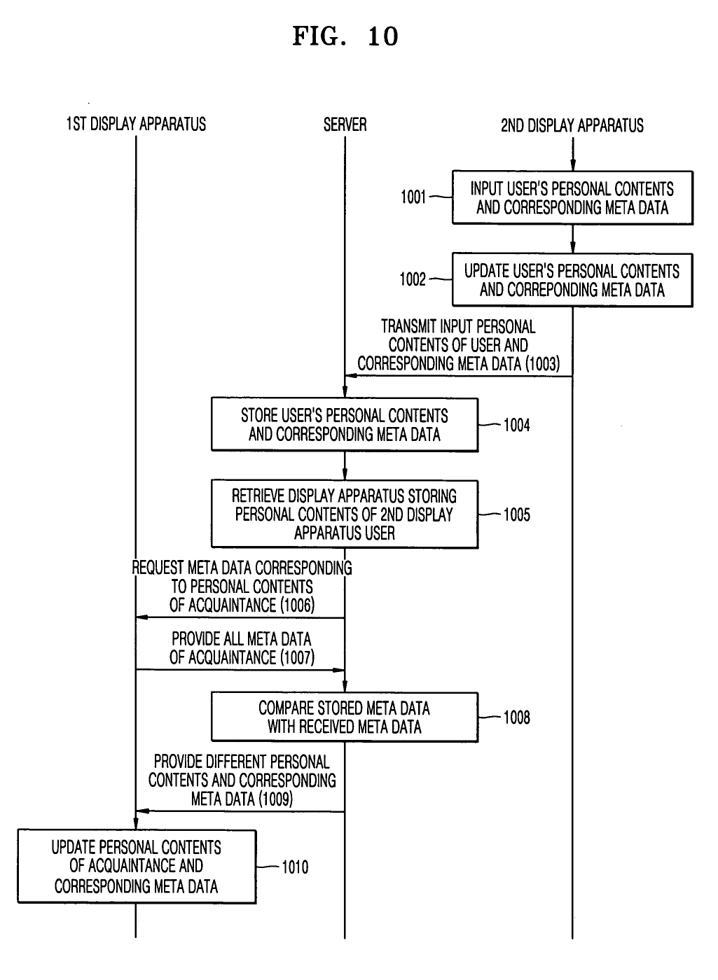

FIG. 10 is another non-limiting example of an operational flowchart of a personal content update process in a personal content transmission method according to the present invention. The first and second display apparatuses can be defined as identical to the first and second display apparatuses, respectively, of FIG. 9. Also, as described above in FIG. 9, if the acquaintance list of the user is set in the display apparatus and at least one personal content of at least one acquaintance is stored according to the method shown in FIG. 6, the personal contents stored in the display apparatus can be updated as shown in FIG. 10.

That is, if a personal content of the second display apparatus user and meta data corresponding to the personal content are input in operation 1001, the second display apparatus updates the personal content of the user and the meta data corresponding to the personal content in operation 1002. Then, the input personal content of the user and the meta data corresponding to the personal content are transmitted to the server 120 in operation 1003. At this time, a plurality of personal contents of the second display apparatus user and meta data corresponding to the plurality personal contents can be transmitted.

The server 120 stores the received personal contents of the user and the meta data corresponding to the personal contents in operation 904. In case of FIG. 5, the received personal content of the user and the meta data corresponding to the personal contents are stored in the second storage unit 504.

The server 120 retrieves a display apparatus storing personal contents of the second display apparatus user, based on an acquaintance list by display apparatus user stored in the first storage unit 503 in operation 1005.

If the display apparatus is retrieved and the retrieved display apparatus is the first display apparatus, the server 120 requests the meta data of the personal content of the second display apparatus user to the first display apparatus in operation 1006. At this time, the second display apparatus user is an acquaintance of the first display apparatus user. Accordingly, the operation 1006 can be defined as requesting the meta data of the personal contents of the corresponding acquaintance.

According to the request, the first display apparatus reads all the stored meta data of the personal contents of the acquaintance and provides the meta data to the server 120 in operation 1007. The server 120 compares all the received meta data of the personal contents of the acquaintance with the meta data of the personal contents stored in the second storage unit 504 in operation 1008.

If the result of the comparison indicates that there are meta data different from the received meta data of the personal contents among the meta data of the personal contents stored in the second storage unit 504, the server 120 reads the different meta data and personal contents corresponding to the meta data from the second storage unit 504 and provides the meta data and personal contents to the first display apparatus in operation 1009. At this time, if a plurality of personal contents and the meta data corresponding to the plurality personal contents are stored in the second storage unit 504 and the meta data items corresponding to all the plurality of personal contents are all different from the received meta data, the server 120 provides the plurality of personal contents and the meta data corresponding to the plurality of personal contents to the first display apparatus.

The first display apparatus updates the personal contents of the acquaintance so that the received personal contents and the meta data corresponding to the personal contents are included in the stored personal contents of the acquaintance and the meta data corresponding to the personal contents in operation 1010.

FIG. 10 shows the case where the user of the second display apparatus is registered as an acquaintance of the first display apparatus. However, if as a result of the retrieval in the operation 1005, a plurality of display apparatuses having the second display apparatus user as an acquaintance registered therein are retrieved, the server 120 performs the operations 1006 through 1010 for the plurality of the retrieved display apparatuses such that the personal contents of the second display apparatus stored in each of the display apparatuses are updated.

In FIG. 10, the second display apparatus can also be the PC 150 of FIG. 1.

In addition, the second display apparatus can be a PMP, camera, camcorder, or mobile phone.

In the cases of FIGS. 9 and 10 described above, if the personal contents of an acquaintance or the personal contents and the meta data corresponding to the personal contents are received by the server 120, the personal contents of the acquaintance or the personal contents and the meta data corresponding to the personal contents stored in the display apparatus are updated.

However, the server 120 may perform in a predetermined period an update process for the personal contents of an acquaintance or the personal contents and the meta data corresponding to the personal contents stored in the display apparatus. If the update is performed in a predetermined period, even when the personal contents of an acquaintance or the personal contents and the meta data corresponding to the personal contents are received, without performing the update process described above, the server 120 stores the received personal contents or the personal contents and the meta data corresponding to the personal contents in the second storage unit 504, and after a predetermined period elapses, performs an update process by using the information stored in the second storage unit 504.

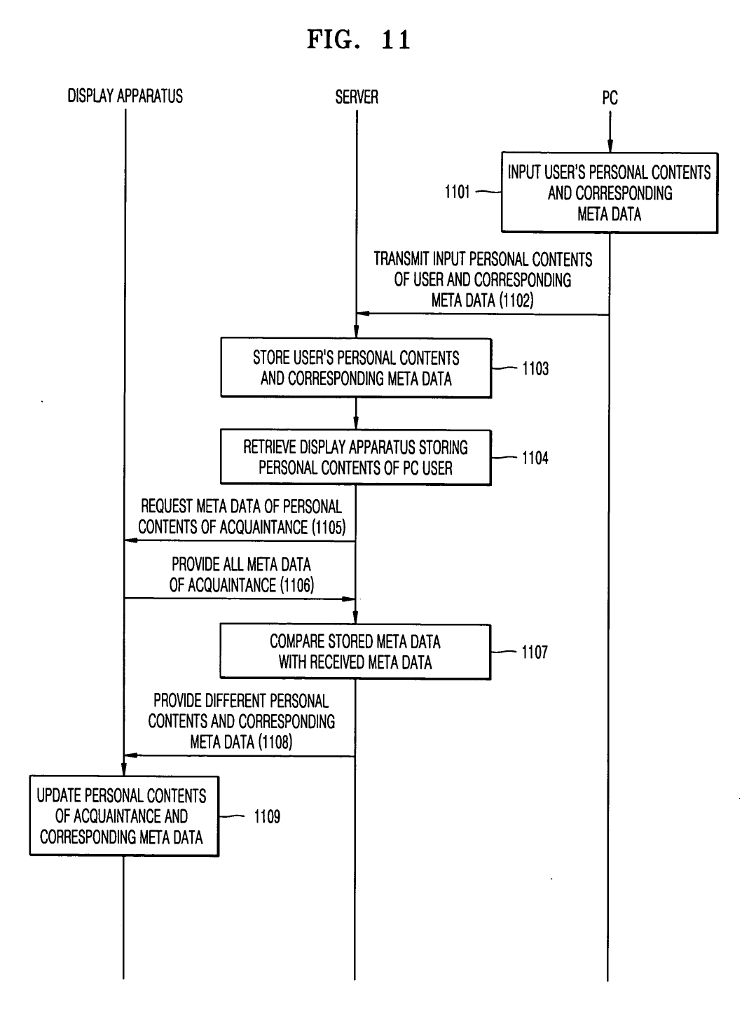

FIG. 11 is still another non-limiting example of an operational flowchart of a personal content update process in a personal content transmission method according to the present invention. Since operations 1102 through 1109 are identical to the operations 1003 through 1010 of FIG. 10, the explanation will be omitted.

Referring to FIG. 11, if the personal contents of the user and the meta data corresponding to the personal contents are input through the PC 150 in operation 1101, the input personal contents and the meta data corresponding to the personal contents are provided to the server 120 so that the personal contents of the user of the PC 150 and the meta data corresponding to the personal contents stored in a display apparatus having the user of the PC 150 as an acquaintance registered therein can be updated.

According to the present invention as described above, the personal contents of an acquaintance are automatically stored in a local display apparatus and the personal contents stored in the local display apparatus are automatically provided to the local display apparatus of the acquaintance. Accordingly, the user can easily share the personal contents with the acquaintance without performing an access operation to a corresponding server (or service provider).

Furthermore, if a mutual authentication procedure is once performed with an acquaintance in the local display apparatus by using authentication information such as contact detail information of the user and the acquaintance, the personal contents stored in the local display apparatuses of the user and acquaintance are automatically updated by a server such that latest personal contents can be conveniently shared between the user and the acquaintance.

While the present invention has been particularly shown and described with reference to the non-limiting, exemplary embodiments thereof, it will be understood by those of ordinary skill in the art that various changes in form and details may be made therein without departing from the spirit and scope of the present invention as defined by the following claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of transmitting personal contents to be shared with at least one acquaintance, by using a display apparatus capable of accessing a server through a network, the method comprising:
the display apparatus receiving at least one personal content of the at least one acquaintance from the server through the network;
storing the received personal contents in relation to each acquaintance; and
if the personal contents of the at least one acquaintance are requested by a user of the display apparatus, reading the personal contents of the at least one acquaintance among the stored personal contents and displaying the read personal contents.

2. The method of claim 1, further comprising:
if the personal contents of the at least one acquaintance are requested by the server, providing all the personal contents of the at least one acquaintance stored in the display apparatus, to the server; and
if at least one personal content of the at least one acquaintance is received from the server, updating the personal contents of the at least one acquaintance stored in the display apparatus.

3. The method of claim 1, further comprising:
if personal contents of the display apparatus user are input, updating personal contents of the user stored in the display apparatus; and
providing the input personal contents of the user to the server.

4. The method of claim 1, wherein the request of the personal contents of the at least one acquaintance is performed based on an acquaintance list of the display apparatus user.

5. A method of transmitting personal contents to be shared with at least one acquaintance, by using a display apparatus capable of accessing a server through a network, the method comprising:
the display apparatus receiving at least one personal content of the at least one acquaintance and meta data corresponding to the at least one personal content from the server through the network;
storing the received personal contents and meta data in relation to each acquaintance; and
if the personal contents of the at least one acquaintance are requested by a user of the display apparatus, reading the personal contents of the at least one acquaintance among the stored personal contents and displaying the read personal contents.

6. The method of claim 5, further comprising:
if the meta data of the personal contents of the at least one acquaintance is requested by the server, providing meta data corresponding to all of the personal contents of the at least one acquaintance stored in the display apparatus, to the server; and
if at least one personal content of the at least one acquaintance and meta data are received from the server, updating the personal contents of the at least one acquaintance and meta data stored in the display apparatus.

7. The method of claim 5, further comprising:
if personal contents of the display apparatus user and the meta data corresponding to the personal contents are input, updating personal contents of the user and the meta data stored in the display apparatus; and
providing the input personal contents of the user and the meta data corresponding to the personal contents to the server.

8. A method of transmitting personal contents to be shared with at least one acquaintance, by using a server capable of accessing at least one display apparatus through a network, the method comprising:
the server requesting the personal contents of the at least one acquaintance stored in the display apparatus;
receiving the personal contents of the at least one acquaintance from the display apparatus;
comparing the received personal contents of the at least one acquaintance with personal contents of the at least one acquaintance maintained in the server; and
if there are personal contents different from the received personal contents of the at least one acquaintance among the personal contents of the at least one acquaintance maintained in the server, providing the different personal contents to the display apparatus.

9. The method of claim 8, wherein the request is performed in each predetermined period.

10. The method of claim 8, wherein if at least one personal content of at least one acquaintance registered in an acquaintance list of the display apparatus is provided to the server, the server performs the request, and the acquaintance list is registered in relation to each display apparatus user in the server.

11. A method of transmitting personal contents to be shared with at least one acquaintance, by using a server capable of accessing at least one display apparatus through a network, the method comprising:
the server requesting meta data of the personal contents of the at least one acquaintance stored in the display apparatus;
receiving the meta data of the personal contents of the at least one acquaintance from the display apparatus;
comparing the received meta data of the personal contents of the at least one acquaintance with meta data of personal contents of the at least one acquaintance maintained in the server; and
if there are meta data different from the meta data of the received personal contents of the at least one acquaintance among the meta data of the personal contents of the at least one acquaintance maintained in the server, providing the different meta data and the personal contents corresponding to the different meta data to the display apparatus.

12. An authenticating method for sharing personal contents with at least one acquaintance by using a display apparatus capable of accessing a server through a network, the method comprising:
if the display apparatus begins a first operation and is connected to the network, requesting contact details of a user of the display apparatus;
if the contact detail information of the user is input, providing the contact detail information of the user to the server;
if a message from the server confirming permission of sharing personal contents in relation to the user is received, requesting input of contact detail information of the at least one acquaintance of the user;
if the contact detail information of the at least one acquaintance is input, providing the contact detail information of the at least one acquaintance to the server; and
if acquaintance list information on acquaintances permitting sharing of personal contents from the server is received, setting the received acquaintance list information as acquaintance list information of the display apparatus user.

13. An authenticating method for sharing personal contents with at least one acquaintance by using a server capable of accessing at least one display apparatus through a network, the method comprising:
if contact detail information is received from the at least one display apparatus, the server confirming to a display apparatus user whether or not sharing of personal contents is permitted, by using an automatic response system;
if the display apparatus user permits sharing of the personal contents, transmitting a message confirming permission of sharing the personal contents to the display apparatus user, and registering the contact detail information of the display apparatus user and unique identification information of the at least one display apparatus;
if contact detail information of the at least one acquaintance of the display apparatus user is received, by using the automatic response system, in relation to each acquaintance based on the received contact detail information of the at least one acquaintance, confirming whether or not sharing of the personal contents is permitted; and
registering an acquaintance list, including information on acquaintances permitted to share the personal contents, as an acquaintance list of the display apparatus user and providing the acquaintance list information of the display apparatus user to the at least one display apparatus,
wherein the server registers the contact detail information of the display apparatus user, the unique identification information of the at least one display apparatus, and the acquaintance list of the at least one display apparatus such that the contact detail information, the unique identification information and the acquaintance list are capable of referring to each other.

14. A display apparatus capable of accessing a server through a network, the apparatus comprising:
a transmission and reception unit communicating data with the server through the network;
a storage unit storing personal contents in relation to each acquaintance;
an input unit inputting commands of at least one of a user and information;
a control unit, wherein if at least one personal content of at least one acquaintance is received through the transmission and reception unit, performing control so that the received personal contents are stored in relation to each acquaintance in the storage unit, and if the at least one personal content of the at least one acquaintance is requested by the input unit, performing control so that the at least one personal content of the at least one acquaintance stored in the storage unit is output; and
a display unit displaying the at least one personal content output from the storage unit.

15. The apparatus of claim 14, wherein if a signal requesting the at least one personal content of the at least one acquaintance is received through the transmission and reception unit, the control unit reads the personal contents of the at least one acquaintance stored in the storage unit and provides the personal contents to the server through the transmission and reception unit, and if at least one personal content of the at least one acquaintance is received through the transmission and reception unit, the control unit updates the personal contents of the at least one acquaintance so that the received personal content is included in the personal contents of the at least one acquaintance stored in the storage unit.

16. The apparatus of claim 14, further comprising:
a content input unit inputting personal contents of a display apparatus user, wherein if at least one personal content is input by the content input unit, the control unit stores the input personal content in the storage unit and transmitting the personal content to the server through the transmission and reception unit.

17. The apparatus of claim 14, wherein if the display apparatus begins a first operation and is connected to the network through the transmission and reception unit, the control unit communicates with the server, based on contact details of the display apparatus user input through the input unit and contact details of an acquaintance desired to share personal contents with the display apparatus user, and confirms whether or not sharing of the personal contents between the display apparatus user and the desired acquaintance is performed, and then sets an acquaintance list of the display apparatus user and requests the personal contents of the desired acquaintance based on the acquaintance list.

18. A display apparatus capable of accessing a server through a network, the apparatus comprising:
a transmission and reception unit communicating data with the server through the network;
a storage unit storing personal contents and meta data corresponding to the personal contents in relation to each acquaintance;
an input unit inputting commands of a user and information;
a control unit, wherein if at least one personal content of at least one acquaintance and the meta data corresponding to the personal content are received through the transmission and reception unit, performing control so that the received personal content and the meta data corresponding to the personal content are stored in the storage unit, and if the at least one personal content of the at least one acquaintance is requested by the input unit, performing control so that the at least one personal content of the at least one acquaintance stored in the storage unit is output; and
a display unit displaying the at least one personal content output from the storage unit.

19. The apparatus of claim 18, wherein if a signal requesting meta data corresponding to the at least one personal content of the at least one acquaintance is received through the transmission and reception unit, the control unit reads the meta data corresponding to the personal contents of the at least one acquaintance stored in the storage unit and provides the meta data to the server through the transmission and reception unit, and if at least one personal content of the at least one acquaintance and the meta data corresponding to the personal content are received through the transmission and reception unit, the control unit updates the personal contents of the at least one acquaintance and the meta data corresponding to the personal contents so that the received personal content and the meta data corresponding to the personal content are included in the personal contents of the at least one acquaintance and the meta data corresponding to the personal contents stored in the storage unit.

20. A server capable of accessing at least one display apparatus through a network, the server comprising:
a transmission and reception unit capable of communicating data with at least one display apparatus;
a first storage unit storing unique identification information of the at least one display apparatus, contact details of a display apparatus user, and an acquaintance list;
a second storage unit storing personal contents of a predetermined person; and
a control unit requesting the personal contents of the predetermined person through the transmission and reception unit to a display apparatus storing the personal contents of the predetermined person, based on the acquaintance list and the unique identification information stored in the first storage unit, and if the personal contents of the predetermined person are received through the transmission and reception unit, examining whether or not there are personal contents different from the received personal contents among the personal contents stored in the second storage unit, and if it is determined that there are different personal contents, performing control so that the different personal contents are transmitted to the at least one display apparatus through the transmission and reception unit.

21. The server of claim 20, wherein the control unit performs an authentication procedure confirming whether or not sharing of the personal contents is permitted, based on the contact details of the display apparatus user and contact details of the predetermined user received through the transmission and reception unit.
